(19) United States
(12) Patent Application Publication
(10) Pub. No.: US 2014/0161311 A1
(43) Pub. Date: Jun. 12, 2014

(54) SYSTEM AND METHOD FOR OBJECT IMAGE DETECTING

(71) Applicant: Hyundai Motor Company, Seoul (KR)

(72) Inventor: Sung Un Kim, Yongin (KR)

(73) Assignee: Hyundai Motor Company, Seoul (KR)

(21) Appl. No.: 14/012,278

(22) Filed: Aug. 28, 2013

(30) Foreign Application Priority Data
Dec. 10, 2012 (KR) 10-2012-0143083

(51) Int. Cl. G06K 9/00

(52) U.S. Cl. CPC G06K 9/00577
USPC 382/103

(57) ABSTRACT

A system for detecting an object generates light control signals to operate one or more lights separately radiating light toward an object to detect the object. Light is radiated toward the object in response to the light control signals, one or more items of image information each including shadow information generated radiating light are collected, and shadow information is collected. The outline of an object is recognized by compounding the collected one or more items of shadow information, thereby detecting the object.

### CROSS-REFERENCE TO RELATED APPLICATION

This application claims priority to and the benefit of Korean Patent Application No. 10-2012-0143083 filed in the Korean Intellectual Property Office on Dec. 10, 2012, the entire contents of which are incorporated herein by reference.

### BACKGROUND

(a) Field of the Invention

The present invention relates to a system and a method for detecting an object image.

(b) Description of the Related Art

There are various methods of recognizing an object using a camera image, but it is difficult to detect an object with high reliability under various environments. In particular, misrecognition occurs due to external light and a similar pattern image in recognition of an object and has a large influence on the recognition rate of an object.

In general, there are various methods of detecting an object. An object detection method based on brightness extracts only camera images with a predetermined level or more of brightness (e.g., a threshold brightness) by irradiating an object to detect. In this method the detection rate of an object is substantially low when the peripheral image is bright or external light such as the sunlight is introduced.

Another object detection method based on color, is a method that is used to detect a human body. This method has a problem in that misrecognition occurs when the color of the peripheral environment and the color of a human body are substantially similar.

Additionally, a method of detecting an object using a 3D (three dimensional) depth camera has the advantage of easily separating an object and the background because it is based on a depth image. However, in this method the cost for a camera system in greatly increased and large processing power is required.

The above information disclosed in this section is only for enhancement of understanding of the background of the invention and therefore it may contain information that does not form the prior art that is already known in this country to a person of ordinary skill in the art.

### SUMMARY

The present invention provides a system and a method having advantages of accurately detecting an object to detect by arranging lights. An exemplary embodiment of the present invention provides a system for detecting an object, which includes a lighting unit that radiates light toward an object or stops radiating light, by controlling one or more lights; and an object checking unit that checks the object through shadows generated on the object.

The lighting unit may include a light controller that generates control signals to turn on or off any of the one or more lights; and a light switch that turns on or off any of the one or more lights in response to the control signals generated by the light controller. In addition, the object checking unit may include an image information receiver that collects one or more items of image information including shadow information generated by one or more lights turned on by the light switch and irradiating the object; a shadow extractor that extracts one or more items of shadow information from one or more items of image information collected by the image information receiver; a shadow compounder that generates one or more shadows by compounding one or more items of shadow information extracted by the shadow extractor; and an object outline checker that checks the object by finding the outline of the object based on the shadows generated by the extractor compounder.

Another exemplary embodiment of the present invention provides a method of detecting an object using a system for detecting an object, and the method includes generating light control signals to operate one or more lights separately radiating light toward an object; radiating light toward the object in response to the light control signals and collecting one or more items of image information each including shadow information generated by the radiated light; collecting one or more items of shadow information from the one or more items of image information; and detecting the object by recognizing the outline of the object, by compounding the collected one or more items of shadow information.

The light control signals may be generated such that one or more lights radiate light in time division in one image frame. In addition, the light control signals may be generated such that the one or more lights radiate light in a plurality of image frames, respectively, to cause one light to radiate light in one image frame. The light control signals may each include identification information of a light.

According to the present invention, since an object may be detected through shadows of the object which are made by lights, reliability of object detection may be improved.

### BRIEF DESCRIPTION OF THE DRAWINGS

FIG. 1 is an exemplary diagram illustrating a method of detecting an object according to an exemplary embodiment of the present invention;

FIG. 2 is an exemplary diagram illustrating the structure of a system for detecting an object according to an exemplary embodiment of the present invention;

FIG. 3 is an exemplary flowchart illustrating a method of detecting an object according to an exemplary embodiment of the present invention; and

FIG. 4 is an exemplary diagram illustrating a method of operating lights according to an exemplary embodiment of the present invention.

### DETAILED DESCRIPTION

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising,” will be understood to imply the inclusion of stated elements but not the exclusion of any other elements.

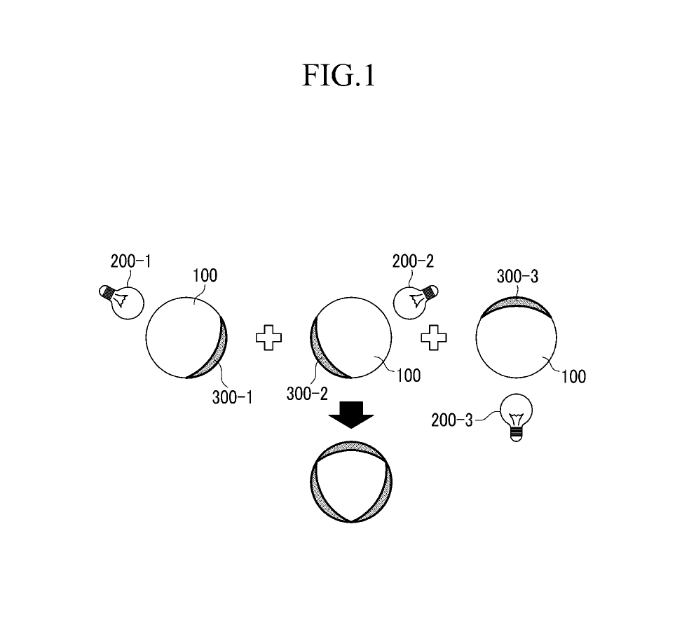

FIG. 1 is an exemplary diagram illustrating a method of detecting an object according to an exemplary embodiment of the present invention.

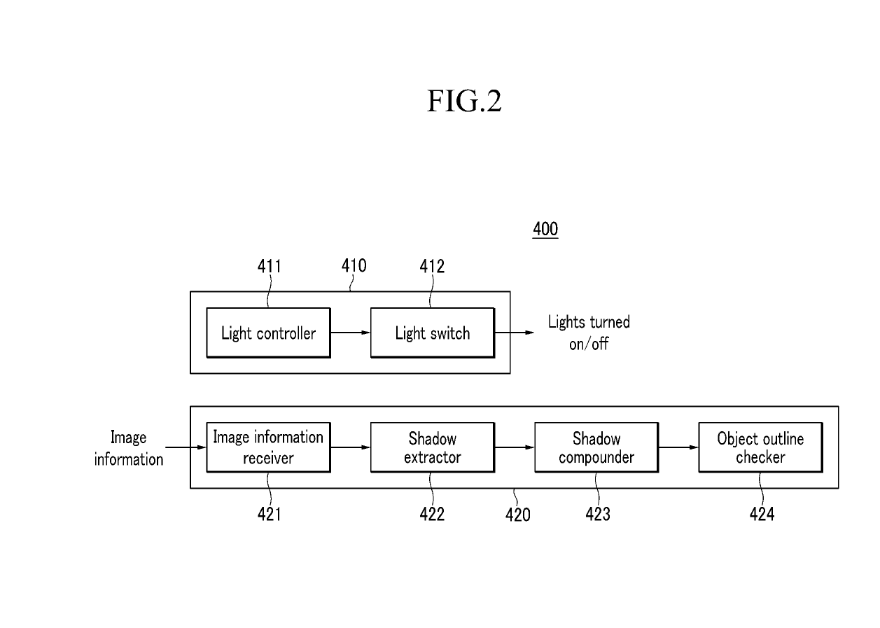

As shown in FIG. 1, an object 100 may be detected by irradiating the object 100 with one or more lights 200-1 to 200-3 and compounding one or more shadows 300-1 to 300-3 generated by the lights 200-1 to 200-3. The structure of a system 400 for detecting an object which detects the object 100 by operating the lights 200-1 to 200-3 and compounding the shadows 300-1 to 300-3 is described with reference to FIG. 2.

An exemplary embodiment of the present invention does not limit the position to dispose the system 400 for detecting an object at, to any one place. Further, in an exemplary embodiment of the present invention, the lights 200-1 to 200-3 are not limited to any specific type and any ones that generate a shadow by irradiating the object 100 may be used.

FIG. 2 is an exemplary diagram illustrating the structure of a system for detecting an object according to an exemplary embodiment of the present invention. As shown in FIG. 2, the system 400 for detecting an object may include a lighting unit 410 that radiates light toward an object or stops radiating light, by operating one or more lights operating with the system 400 for detecting an object, and an object checking unit 420, executed by an object checking controller to check an object through the shadows of the object generated by the light from the lighting unit 410.

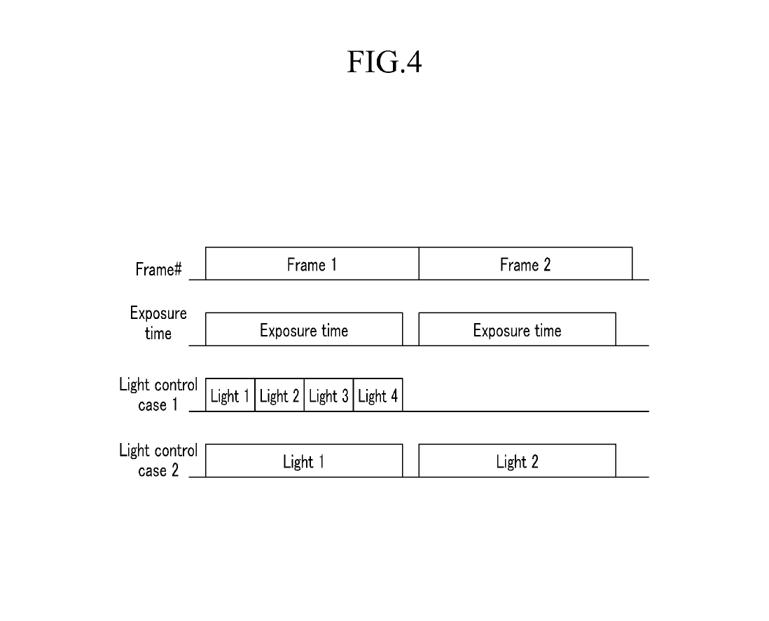

Specifically, the lighting unit 410 may include a light controller 411 and a light switch 421, and the object checking unit 420 may include an image information receiver 421, a shadow extractor 422, a shadow compounder 423, and an outline checker 424. The light controller 411 may be configured to generate control signals to turn on or off any of the one or more lights operating with the system 400 for detecting an object. The control signals may each include identification information of the light. Further, since the control signals may be generated by various methods, the method of generating the control signals is not limited to any one method in the description. However, in the description of an exemplary embodiment of the present invention, it is exemplified to generate control signals such that one or more lights may be sequentially turned on or off for the convenience of description. An exemplary embodiment of operating light for control signals is described first with reference to FIG. 4.

FIG. 4 is an exemplary diagram illustrating a method of controlling lights according to an exemplary embodiment of the present invention. As shown in FIG. 4, lights may be controlled to collect and combine shadow information from a plurality of items of information, that is, several sheets of image frames. It may be possible to generate control signals to radiate light in time division in one frame or it may be possible to generate control signals to radiate light over several frames.

When light is radiated in time division in one frame under the assumption that four lights are provided, as shown in “Light control case 1”, control signals may be generated to turn the four lights on or off in time division in one frame. Alternately, it may be possible to turn on or off only one light in one frame and radiate light through several frames as shown in “Light control case 2”. A control signal may be generated such that the time for turning on or off a light may be controlled within an “exposure time” even in one frame.

Referring back to FIG. 2, the light switch 412, operated by the light controller 411, may be configured to turn on or off one light connected to the light switch 412 based on the generated control signal. In addition, the light switch 412 may correspond to the number of lights, but it is exemplified in an exemplary embodiment of the present invention that one light switch 412 is configured to turn on or off one or more lights based on the identification information of the lights =included in control signals, for the convenience of description.

The image information receiver 421 may be configured to collect image information generated by one or more lights turned on by the light switch 412 and irradiating an object. The image information may include shadow information and one or more items of image information may be collected. Since it is exemplified that the light controller 411 may be configured to generate control signals to sequentially turn on one or more lights, a plurality of items of image information including shadows generated by light may also be generated.

The shadow extractor 422 may be configured to extract shadow information from one or more items of image information received by the image information receiver 421. There are many methods of extracting shadow information from image information and an exemplary embodiment of the present invention does not specify any one method.

The shadow compounder 423 may be configured to generate one item of shadow information by compounding one or more items of information extracted by the shadow extractor 422. Since one item of shadow information is included in one item of image information, such that when only one item of shadow information is transmitted from the shadow extractor 422, the shadow compounder may be configured to wait until the shadow information from all of the lights is collected, and compound the shadow information after a plurality of items of shadow information is collected. Furthermore, the object outline checker 424 may be configured to recognize the outline of an object based on the shadow information generated by the shadow compounder 423.

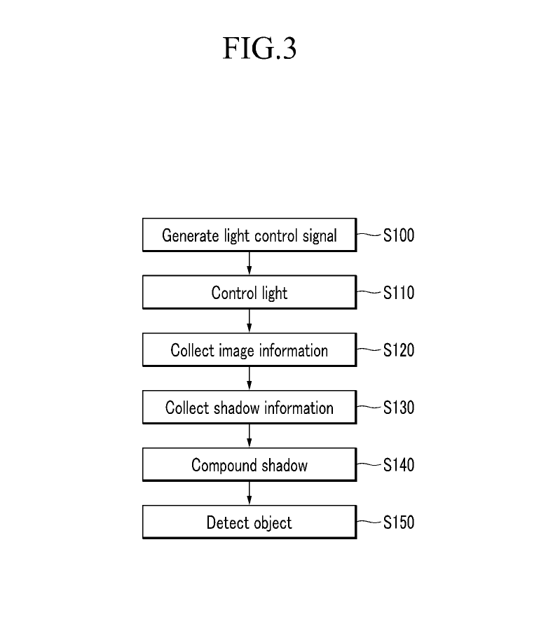

A method of detecting an object using the system is described with reference to FIG. 3. FIG. 3 is an exemplary flowchart illustrating a method of detecting an object according to an exemplary embodiment of the present invention. As shown in FIG. 3, the light controller 411 may be configured to generate light control signals to turn on or off one or more lights that operate with each other in a system for detecting an object (S100). The light switch 412 may be configured to control a plurality of lights based on the light control signals generated in S100 (S110).

The image information receiver 421 may be configured to collect image information including the shadows generated when the lights radiate light toward an object in S110 (S120). All of the one or more lights may be operated in one frame or one light may be operated in one frame and alternatively, all the lights may be operated in a plurality of frames, thus, the image information collected in S120 may be one item of image information or a plurality of items of image information.

The shadow extractor 422 may be configured to collect one or more items of shadow information from one or more items of image information collected in S120 (S130). The shadow compounder 423 may be configured to generate one item of shadow information by compounding the one or more items of shadow information collected in S130 (S140), and the object outline checker 424 may be configured to recognize the object based on the generated outline of the object (S150).

In other words, since it may be possible to detect only the outline of an object from the shadows of the object generated by the lights turned on and off by the light switch 421, it may be possible to recognize the substantially entire shape of the object. Therefore, the substantially entire outline of an object to be detected may be recognized by selectively turning on or off one or more lights around the object to generate shadows, and by compounding one or more shadows.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A system for detecting an object, comprising:
a light controller configured to radiate light toward an object or stops radiating light, by operating one or more lights; and
an object checking controller configured to check the object using shadows generated on the object.

2. The system of claim 1, wherein the light controller is further configured to:
generate control signals to turn on or off any of the one or more lights; and
operate a light switch to turn on or off any of the one or more lights in response to the control signals.

3. The system of claim 2, wherein the object checking controller is further configured to:
collect one or more items of image information including shadow information generated by one or more lights turned on by the light switch and irradiating the object;
extract one or more items of shadow information from the collected one or more items of image information;
generate one or more shadows by compounding the extracted one or more items of shadow information; and
check the object by recognzing the outline of the object based on the generated shadows.

4. The system of claim 1, wherein the light control signals are generated to radiate the one or more lights in a plurality of image frames, respectively, to cause one light to radiate light in one image frame.

5. The system of claim 1, wherein the light control signals are generated to radiate light over a plurlaity of frames.

6. A method of detecting an object using a system for detecting an object, the method comprising:
generating, by a light controller, light control signals to operate one or more lights separately radiating light toward an object;
radiating, by the light controller, light toward the object in response to the light control signals;
collecting, by a object checking controller, one or more items of image information each including shadow information generated by the radiated light;
collecting, by the object checking controller, one or more items of shadow information from the one or more items of image information; and
detecting, by the object checking controller, the object by recognizing the outline of the object, by compounding the collected one or more items of shadow information.

7. The method of claim 6, wherein the light control signals are generated to radiate one or more lights in time division in one image frame.

8. The method of claim 6, wherein the light control signals are generated to radiate the one or more lights in a plurality of image frames, respectively, to cause one light to radiate light in one image frame.

9. The method of claim 6, wherein the light control signals are generated to radiate light over a plurlaity of frames.

10. The method of claim 7, wherein the light control signals each include identification information of a light.
